(19) United States
(12) Patent Application Publication
(10) Pub. No.: US 2022/0151225 A1
(43) Pub. Date: May 19, 2022

(54) VITRIFICATION STRAW AND CRYOPRESERVATION DEVICE

(71) Applicant: Sravan Kumar Payeli, Bangalore (IN)

(72) Inventors: Sravan Kumar Payeli, Bangalore (IN); Pavani Srividya Mocharla, Bangalore (IN)

(21) Appl. No.: 17/433,527

(22) PCT Filed: Feb. 25, 2019
(86) PCT No.: PCT/IN2019/050149

§ 371 Date: Aug. 24, 2021

(51) Int. Cl. A01N 1/02

(52) U.S. Cl. CPC A01N 1/0268

(57) ABSTRACT

Examples of a cryopreservation device (200, 300) for storing reproductive biological material are described herein. The device (200, 300) includes a vitrification straw (202, 302) having an elongated member (208, 306) with a planar base and a triangular cross-section. The vitrification straw (202, 302) further includes a tip member (208, 308) extending away from one end of the elongated member (208, 306). At least a portion of the tip member (208, 308) defines a cavity (212) to receive the biological material. Further, the cryopreservation device includes a sheath (204, 304, 402) for being disposed over the tip member (208, 308) of the vitrification straw (202, 302).

### TECHNICAL FIELD

The present subject matter relates, in general, to cryopreservation and, in particular but not exclusively, to a vitrification straw and a cryopreservation device.

### BACKGROUND

Cryopreservation is use of very low temperatures to preserve a biological material, such as tissues, cells, male gametes, and female gametes, in situations where it is not possible or convenient to use or manipulate the biological material. Cryopreservation is often desired to preserve oocytes or embryos after they are harvested and cryogenically store them. Cryopreservation plays an important role in assisted reproductive techniques, as it enables the collected reproductive cells to be used for future treatments.

### BRIEF DESCRIPTION OF DRAWINGS

The detailed description is provided with reference to the accompanying figures. It should be noted that the description and the figures are merely examples of the present subject matter and are not meant to represent the subject matter itself.

FIG. 1 depicts a perspective view of a vitrification straw, according to an example implementation of the present subject matter;

FIG. 2 illustrates a perspective view of a cryopreservation device, according to an example implementation of the present subject matter;

FIG. 3A illustrates another perspective view of the cryopreservation device, according to an example implementation of the present subject matter;

FIG. 3B illustrates a perspective view of a sheath of the cryopreservation device, according to an example implementation of the present subject matter; and

FIG. 4 illustrates a perspective view of a support structure of a cryopreservation device, according to an example implementation of the present subject matter.

Throughout the drawings, identical reference numbers designate similar elements, but may not designate identical elements. The figures are not drawn to the scale, and the size of some parts may be exaggerated for better illustration of the example shown. Moreover, the drawings provide examples and/or implementations consistent with the description; however, the description is not limited to the examples and/or implementations provided in the drawings.

### DETAILED DESCRIPTION

Biological material, such as oocytes or embryos, are frequently cryopreserved to temporally extend their viability and usefulness in future time for biomedical applications. During cryopreservation, the biological material extracted from a patient is transferred to a multi-well plate in a medium. To preserve the biological material, the biological material is carried and stored in a straw which is placed into a tank filled with liquid nitrogen. In an example, the straw may also include electrolytes and chemical compounds that protect the biological material during freezing process. Usually, multiple straws are stored within a single tank.

Existing straws may include a square or round or hexagonal body portion having a visible mark on one end to facilitate correct placement of the straw. The straw may also include a flattened area near the visible mark to provide identification detail's of the patient, such as a patient ID, name, age, date, number, stage etc. In addition, the body portion of the straw may include a logo, such as of a manufacturer. Such a logo may assist a user in determining an orientation of the straw while loading the oocytes. Further, the existing straw includes a tip member extending longitudinally away from the body portion. The tip member may include a surface for receiving the biological material, such as oocytes to be preserved. Further, an edge of the surface may be marked with a dark color, such as black color, to provide guidance while loading the oocytes in the straw.

Once the oocytes are loaded on to the surface of the tip member, the tip member may be covered with a cover. The dark colored marking on the tip member also helps in assembling the cover over the tip member. As the oocytes are stored and preserved at very low temperatures, the cover is brought to an optimal temperature before putting the cover on to the tip member. For example, the cover may be dipped in the tank filled with liquid nitrogen. For example, a practitioner may hold the cover with a forceps and dip the cover in the tank. Inside the liquid nitrogen, the practitioner has to close the tip member with the cover. To facilitate in assembling the cover and the straw, an edge of the cover proximal to the tip member is provided with a marking, preferably with a dark color. The practitioner may therefore align the dark color of the tip member and that of the cover inside liquid nitrogen.

However, the shape of the existing straws is such that when any force is applied on the body of the straws, the straws are prone to roll over. Such an accidental roll over of the straw may contaminate the tip member of the straw. Further, the marks, such as the orientation mark and the logo, provided on the body portion of the straw, are not tactile. As a result, the user needs to visually check or feel for the orientation of the straw, in time and during the loading and thawing procedures. As stipulated time in seconds is of importance n cryopreservation, the practitioner may have to spend more time to visually check the orientation of the straw. Moreover, the markings provided on the tip member may mask the oocytes that are loaded in the tip member. This may cause a practitioner to miss out on such oocytes while removing from the straw.

Further, before storing the strew in the tank, the cover is put over the tip member. As the oocytes are preserved at very low temperatures, the cover is to be kept or held in the liquid nitrogen for some time. In addition, while putting the cover over the tip member in the presence of liquid nitrogen, the practitioner may not be able to clearly see the markings provided on the tip member and the cover. This may cause spillage of the oocytes from the tip member. However, this may be cumbersome and involves both hands of the practitioner to remain engaged in holding a straw and a cover with forceps.

For example, multiple vitrification straws are placed longitudinally in the tank with the cap pointing downwards where the biological material is towards the bottom of the tank. Also, in case the straws fall inside the tank due to any reason, the practitioner may try to pick up the straw from the tank with the help of forceps. However, the practitioner does not have any means to ensure the orientation of the straw while picking up by forceps. As a result, the practitioner may mistakenly pick out the straw from the tip member. If the tip member is exposed to air, the biological material held by the tip member may fluctuate in temperature very rapidly between room temperature and the liquid nitrogen temperature in a fraction of seconds leading to deleterious effects on quality of the biological material. In addition, as the tank is filled with liquid nitrogen, it may become be difficult to maneuver and pick the straw from a desired edge, i.e., from the opposite end of the biological material loaded area. As the straws have to be held precisely and stored in a predefined position inside the tank, such trial and error methods by the practitioner may affect procedure and further effect on the biological material survival upon thawing.

Examples of the present subject matter relating to storage of reproductive biological material, such as oocytes and embryos are described herein. Specifically, the present subject matter enables a practitioner to determine an orientation of the vitrification straw without having to look at the vitrification straw. In addition, the present subject matter facilitates a practitioner to assemble the cover without depending on the dark color markings on the tip member and the cover.

The present subject matter describes a vitrification straw and a cryopreservation device for storing reproductive biological material, such as oocytes and embryos. The cryopreservation device includes the vitrification straw and a sheath. In an example, the vitrification straw includes an elongated member having a planar base and a triangular cross-section. The triangular cross-section prevents any roll over of the vitrification straw by preserving optimal center of gravity when force is applied. In addition, side surfaces of the elongated member provide sufficient space for labelling. Further, the vitrification straw includes a tip member extending away from one end of the elongated member. The tip member may define a cavity at one portion to receive the biological material.

In an implementation, the vitrification straw includes a planar handle integrated with the elongated member at an end opposite to the tip member. The planar handle is perpendicular to the planar base of the elongated member. As the planar extends in one direction, the planar handle facilitates in keeping the vitrification straw in a correct orientation by virtue of holding. In addition, a planar surface of the planar handle provides a confident grip to the user. In an aspect, the planar handle may be provided with a metal clip, such as an iron clip, to define orientation of the straw. Thus, the metal clip ensures that in case the vitrification straw falls into the tank, the vitrification straw can be picked up by a magnetic rod from inside the liquid nitrogen with precision, by the end of the planar handle and not from the tip member where the oocytes or embryos are deposited

Further, the cryopreservation device includes a guiding member coupled to the sheath to securely hold the vitrification straw. In an implementation, the guiding member may be in-line with the sheath to slidably receive the vitrification straw. In such configuration, the tip member is received by the sheath while the elongated member supports on the guiding tie member. The guiding member therefore facilitates in aligning the tip member with the sheath in the liquid nitrogen without depending on any markings. In another implementation, the guiding member may be pivotably coupled to a closed end of the sheath for being lockably rested on the elongated member when the tip member is received by the sheath. The closed end is opposite to the open end of the sheath. The guiding member therefore acts like a handle of the sheath thereby allowing the practitioner to hold the guiding member without using the forceps manipulation inside the liquid nitrogen.

Although the biological material has been mentioned as oocytes, this example is not meant to be construed in a limiting sense. The present subject matter is also applicable for other biological material, such as tissues, cells, embryos, and so on.

The present subject matter is further described with reference to the accompanying figures. Wherever possible, the, same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, designs and examples of the present subject matter, as well as specific examples thereof, are intended to encompass equivalents thereof.

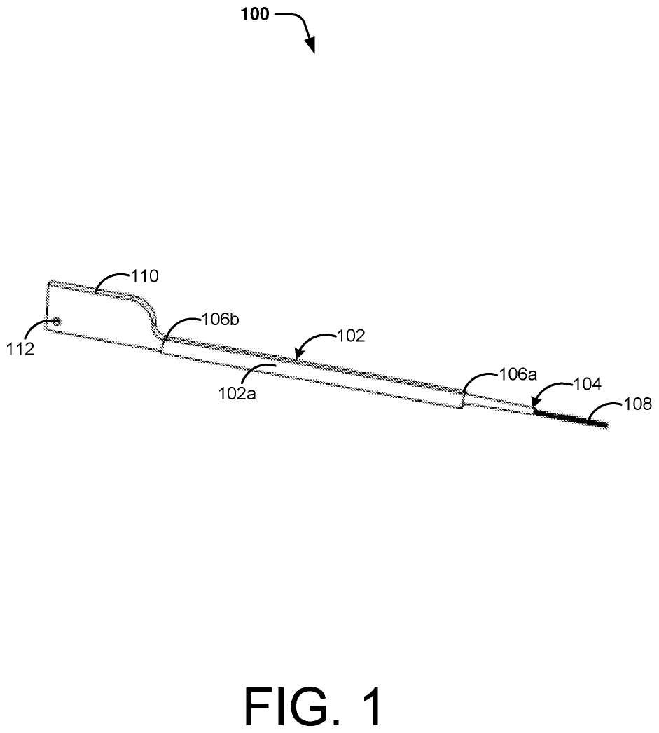

FIG. 1 depicts a perspective view of a vitrification straw 100 (hereinafter referred to as straw 100), according to an example implementation of the present subject matter. The straw 100 is open at one end and closed at another end. In an example, the straw 100 is made of a plastic material or a non-reactive material. The straw 100 includes an elongated member 102 having a planar base (not shown) and a triangular cross-section. In the present implementation, the elongated member 102 may have a length of about 10 cm to about 15 cm. Further, the elongated member 102 may have a height of about 2 mm to about 5 mm.

The triangular crass-section enables better gripping of the straw 100 when placed on any flat surface. The elongated member 102 thereby facilitates in placing of the straw 100 without causing any roll over. Further, side surfaces 102a of the elongated member 102 provides sufficient labelling space to provide details pertaining to a patient, such as name, age, blood group, etc. In an example, the triangular cross-section of the elongated member 102 may be an isosceles triangle, an equilateral triangle, and so on. Although, the elongated member 102 is depicted to have a triangular cross-section, the elongated member 102 may have cross-section of any other shape that prevents roll over of the straw 100.

Further, the straw 100 includes a tip member 104 extending away from one end 106a of the elongated member 102. The tip member 104 may be made of a material, such as plastic or any non-reactive in nature that is partially flexible to provide ease in carrying the oocytes or embryos curing loading or thawing procedures. At least a portion of the tip member 104 may include a cavity 108. In an example, the cavity 108 may include a concaved surface, such as forming a spoon or half circle, defined at the portion of the tip member 104 to receive the oocytes or embryos. In another example, the cavity 108 may be in the form of a hollow cylinder defined in the portion of the tip member 104 to receive the oocytes.

In an implementation, the straw 100 includes a planar handle 110 integrated with the elongated member 102 at an end 106b opposite to the end 106a tip member 104. In an example, the planar handle 110 may be made of a plastic material or any non-reactive material. Further, the planar handle 110 may have a length of about 2 cm to about 3 cm. Further, the planar handle 110 may have a height of about 0.2 cm to about 1 cm height. In an example, the planar handle 110 may have a thickness of about 1 mm to about 3 mm. The planar handle 110 may be substantially perpendicular to the planar base of the elongated member 102. In an example, the planar handle 110 includes an edge (not shown) coplanar to the planar base of the elongated member 102. Thus, the planar handle 110 extends unidirectionally opposite to the planar base of the elongated member 102. The planar structure of the planer handle 110 enables a user, such as the practitioner to grip the straw 100 without the fear of the straw 100 being rolled over at any given point in time during embryo loading and thawing procedures.

Further, the planar handle 110 may be. provisioned for being attached to a metallic body. In an example, at least a portion of the planar handle 110 may be made of a metallic material. In another example, the planar handle 110 may include a slot 112 for receiving a metal clip, such as an iron clip. Therefore, in case when the straw 100 falls within a tank filled with liquid nitrogen, the straw 100 could be easily detected by a magnetic rod or any such accessory. The metallic body of the planar handle 110 ensures that the straw 100 is always lifted from the planar handle 110 and not from the tip member 104 where the embryos are deposited. In an example, the elongated member 102, the tip member 104 and the handle 110 may be made of same material, such as a plastic material or any other embryo safe material.

The vitrification straw 100 as described above provides a foolproof device to assist in cryopreservation of oocytes. The unidirectional handle 110 of the straw 100 provides a rigid grip to the straw 100. In addition, the unidirectional handle ensures that the straw 100 is placed in correct orientation without having the practitioner to look at the straw 100 of feel the orientation provided by manufacturer identification side. Thus, the concentration and focus of the practitioner may remain undivided. Further, the triangular cross-section of the elongated member 102 prevents the straw 100 from overturning when the straw 100 is placed on a flat surface and avoid roll over if any force is applied unintentionally by preserving center of gravity.

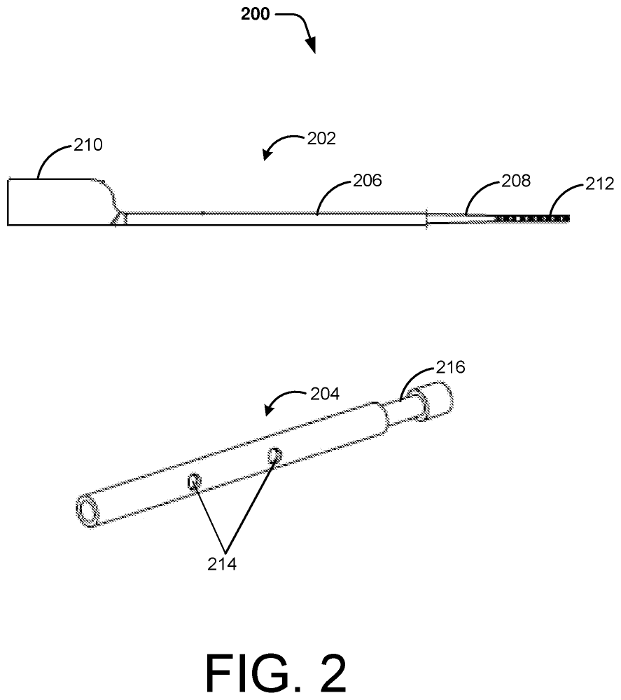

Referring now to FIG. 2, a perspective view of a cryopreservation device 200 is illustrated, according to an example implementation of the present subject matter. The cryopreservation device 200 is an assisted reproduction device intended to be used for loading, holding, preserving, and storing oocytes or embryos in liquid nitrogen. The cryopreservation device 200 includes a vitrification straw 202, such as the vitrification straw 100 and a sheath 204. Thus, the vitrification straw 202 includes an elongated member 206, a tip member 208, and a planar handle 210. The elongated member 208 may include a planar base (not shown) and a triangular cross-section. The tip member 208 of the vitrification straw 202 extends away from one end of the elongated member 206. In an example, at least a portion of the tip member 208 defines a cavity 212 to receive biological material, such as oocytes or embryos. The sheath 204 may be configured to be disposed over the tip member 208 of the vitrification straw 202.

The planar handle 210 may be integrated with the elongated member 206 at an end opposite to the tip member 208. Further, the planar handle 210 may be perpendicular to the planar base of the elongated member 208. As described with reference to FIG. 1, the planar handle 210 includes an edge coplanar to the planar base of the elongated member 208. In an example, the vitrification straw 202 and the sheath 204 have been designed to provide a secure seal once the sheath 204 is assembled over the tip member 208 of the vitrification straw 202.

In an implementation, the sheath 204 may be a hollow tubular structure as depicted in FIG. 2. The sheath 204 may include a plurality of holes 214 to prevent locking of air inside the sheath 204 once the sheath 204 is put over the tip member 208. The escaping of air through the holes 214 facilitate in maintaining the temperature of the frozen material and prevents any cap burst opening. In addition, a lower section 216 of the sheath 204 may hold certain amounts of liquid nitrogen such that when the tip member 208 carrying the oocytes or embryos is inserted in the sheath 204, the temperature of the oocytes is maintained. Furthermore, the liquid nitrogen in the lower section 216 of the sheath 204 preserves the temperature of the frozen material during any unintentional quick exposure of the straw 202.

In operation, a user, such as a practitioner may hold the straw 202 by the handle 210 and insert the tip member 208 inside the sheath 204. When the sheath 204 is assembled over the tip member 208, the liquid nitrogen held inside lower section 216 of the sheath 204 flows upwards towards the tip member 208. Accordingly, the liquid nitrogen inside the sheath 204 facilitates in maintaining temperature of the oocytes or embryos during any unintentional quick exposure to the air.

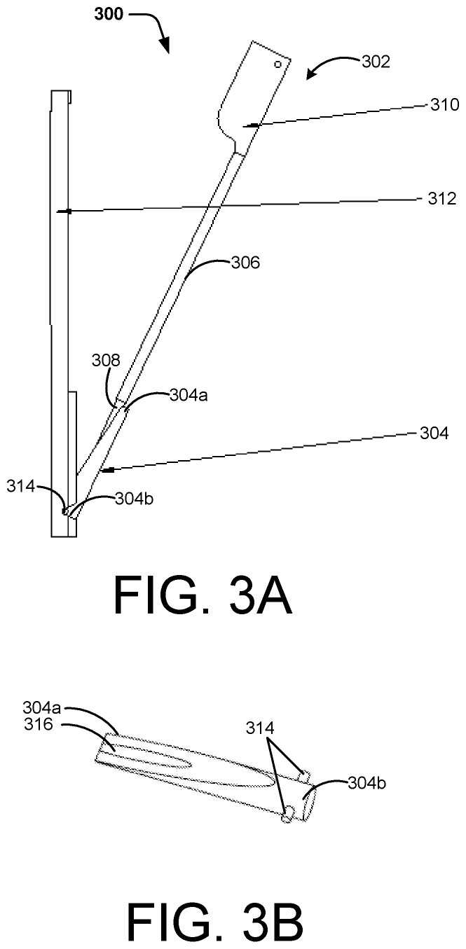

Now referring to FIG. 3A, a cryopreservation device 300 is depicted according to another implementation of the present subject matter. In this implementation, the cryopreservation device 300 may include a vitrification straw 302 and a sheath 304. FIG. 3B depicts a perspective view of the sheath 304, according to the present implementation of the present subject matter. The vitrification straw 302 may include an elongated member 306, a tip member 308, and a planar handle 310. Further, the cryopreservation device 300 may include a guiding member 312. The guiding member 312 may be an elongate structure and may facilitate in handling the sheath 304.

As depicted in FIG. 3B, the sheath 304 may include an open end 304a and a closed end 304b. The sheath 304 also includes two protrusions 314 near the closed end 304b. The protrusions 314 facilitate the sheath 304 to be disposed on the guiding member 312. For example, the guiding member 312 may include slots (not shown) corresponding the protrusions 314 such that the during assembly, the protrusions 314 fit in the slots. Such an arrangement facilitates the sheath 304 to be pivotably coupled to the guiding member 312. Further, the open end 304a of the sheath 304 includes a recess 316 to receive the tip member 308 of the vitrification straw 302.

The elongated structure of the guiding member 312 may act as a handle for holding the sheath 304 while assembling the vitrification straw 302. Thus, the practitioner may not have to use forceps to assemble the vitrification straw 302 into the sheath 304. In addition, the sheath 304 defines a path for the vitrification straw 302 to follow. For example, as soon as the tip member 308 of the vitrification straw 302 aligns with the recess 316 of the sheath 304, the elongated member 304 of the vitrification straw 302 may lockable rest on the guiding member 312.

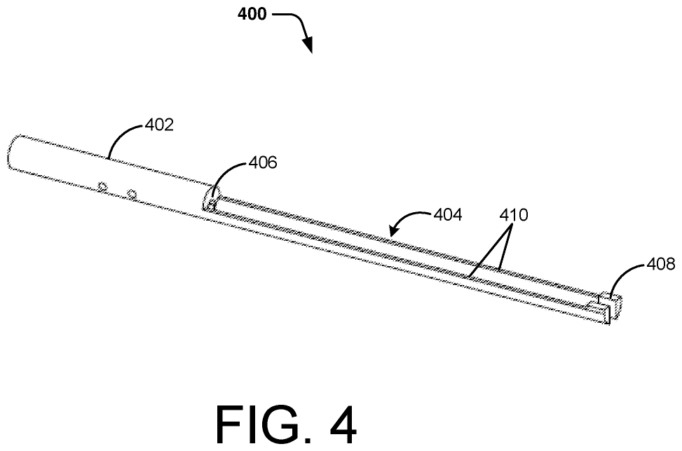

Referring now to FIG. 4, a support structure 400 is depicted according to an implementation of the present subject matter. In this implementation, the support structure 400 may include a sheath 402 coupled with a guiding member 404. The sheath 402 may have a hollow tubular structure to receive the tip member of a vitrification straw, such as the straw 302. In an example, the guiding member 404 may be an elongate structure and include a first end 406 and a second end 408. The first end 406 may be coupled to the sheath 402 and the second end 408 may be open. Further, the guiding member 404 may include side rails 410 to enable the vitrification straw to be easily slid through the guiding member 404 into the sheath 402. In an example, the second end 408 may include a slit or cut out corresponding to a planar handle of the vitrification straw.

Thus, the practitioner does not have to look for any visible markings on the sheath 402 as well as the straw to ensure that a tip member of the vitrification straw and the sheath 402 are aligned. In addition, the guiding member 404 may act as a handle of the sheath 402. As a result, the practitioner may not have to use forceps to assemble the sheath 402 over the vitrification straw. The elongate structure of the guiding member 404 provides a better grip to the user and reduces the chances of error.

In operation, a user such as a practitioner may hold the straw, in one hand, from a handle, such as the planar handle 410. Further, the user may hold the sheath 402 by the guiding member 404, in the other hand. In an example, the support structure 400 is held in a manner that the sheath 402 is immersed in liquid nitrogen and the guiding member 404 is held by the user by the open end 408. The user may simply align the tip member of the vitrification straw with the open end 408 of the guiding member 404 and slide the straw along the guiding member 404 such that the elongated member of the vitrification straw rests on the guiding member 404 and the tip member (holding the oocytes or embryos) goes inside the sheath 402 and the elongated member of straw locks inside the slit of the open end 408.

Although the present subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter.

I/We claim:

1. A vitrification straw (100, 202, 302) for storing reproductive biological material, the vitrification straw (100, 202, 302) comprising:
an elongated member (102, 208, 306) having a planar base and a triangular cross-section; and
a tip member (108, 208, 308) extending away from one end of the elongated member (102, 208, 306), at least a portion of the tip member (108, 208, 308) defines a cavity (108, 212) to receive the biological material.

2. The vitrification straw (100, 202, 302) as claimed in claim 1 comprising a planar handle (110, 210, 310) integrated with the elongated member (102, 208, 306) at an end opposite to the tip member (108, 208, 308), the planar handle (110, 210, 310) being perpendicular to the planar base of the elongated member (102, 208, 306).

3. The vitrification straw (100, 202, 302) as claimed in claim 2, wherein the planar handle (110, 210, 310) includes an edge coplanar to the planar base of the elongated member (102, 208, 306).

4. The vitrification straw (100, 202, 302) as claimed in claim 2, wherein at least a portion of the planar handle (110, 210, 310) is made of a metallic material.

5. The vitrification straw (100, 202, 302) as claimed in claim 2, wherein the planar handle (110, 210, 310) comprises a slot (112) for being attached to a metallic body.

6. The vitrification straw (100, 202, 302) as claimed in claim 1, wherein the triangular cross-section is an isosceles triangle.

7. The vitrification straw (100, 202, 302) as claimed in claim 1, wherein the triangular cross-section is an equilateral triangle.

8. The vitrification straw (100, 202, 302) as claimed in claim 1, wherein the tip member (108, 208, 308) is made from a flexible material.

9. A cryopreservation device (206, 300) for storing reproductive biological material, the cryopreservation device (200, 300) comprising:
a vitrification straw (202, 302) comprising:
an elongated member (208, 306) having a planar base and a triangular cross-section; and
a tip member (208, 308) extending away from one end of the elongated member (208, 306), at least a portion of the tip member (208, 308) defines a cavity (212) to receive the biological material; and
a sheath (204, 304, 402) for being disposed over the tip member (208, 308) of the vitrification straw (202, 302).

10. The cryopreservation device (200, 300) as claimed in claim 9 comprising a planar handle (210, 310) integrated with the elongated member (208, 306) at an end opposite to the tip member (208, 308), the planar handle (210, 310) being perpendicular to the planar base of the elongated member (208, 306).

11. The cryopreservation device (200, 300) as claimed in claim 10, wherein the planar handle (210, 210) includes an edge coplanar to the planar base of the elongated member (208, 306).

12. The cryopreservation device (200, 300) as claimed in claim 10, wherein at least a portion of the planar handle (210, 310) is made of a metallic material.

13. The cryopreservation device (200, 300) as claimed in claim 10, wherein the planar handle (210, 310) comprises a slot for being attached to a metallic body.

14. The cryopreservation device (200, 300) as claimed in claim 9, wherein the triangular cross-section is an isosceles triangle.

15. The cryopreservation device (200, 300) as claimed in claim 9, wherein the triangular cross-section is an equilateral triangle.

16. The cryopreservation device (200, 300) as claimed in claim 9, wherein the sheath (204) includes at least one hole (212) to allow escaping of trapped air.

17. The cryopreservation device (200, 300) as claimed in claim 9, comprising a guiding member (312, 404) coupled to the sheath (304, 402) to securely hold the vitrification straw (202, 302).

18. The cryopreservation device (200, 300) as claimed in claim 17, wherein the guiding member (312, 404) is disposed adjacent to an open end (402a) of the sheath (402) for slidably receiving the elongated member (208, 306) along a length of the guiding member (312, 404), when the tip member (208, 308) is received by the sheath (402).

19. The cryopreservation device (200, 300) as claimed in claim 17, wherein a closed end (304b) of the sheath (304) is pivotably coupled to the guiding member (312, 404) for lockably resting the elongated member (208, 306) on the guiding member (312, 404) when the tip member (208, 308) is received by the sheath (304), wherein the closed end (304b) of the sheath is opposite to an open end (304a).
